(19) United States
(12) Patent Application Publication
(10) Pub. No.: US 2025/0363231 A1
(43) Pub. Date: Nov. 27, 2025

(54) SYSTEM AND METHOD OF DATA ABSTRACTION FROM NETWORK DATA SOURCES

(71) Applicant: DISH Wireless L.L.C., Littleton, CO (US)

(72) Inventors: Mihir Bhatt, Denver, CO (US); Madhuri Muttreja, Parker, CO (US)

(21) Appl. No.: 18/972,178

(22) Filed: Dec. 6, 2024

Related U.S. Application Data
(60) Provisional application No. 63/650,299, filed on May 21, 2024.

(51) Int. Cl. G06F 21/62

(52) U.S. Cl. CPC G06F 21/6218

(57) ABSTRACT

Telecommunications systems, computer devices and systems, and methods are provided. One example method, performed by a data abstraction layer of a telecommunications system for a network, includes accessing data elements associated with a network function of the network, performing abstraction on the data elements to generate one or more data products, receiving a customer request for a service on the network, identifying the data product related the service, and provisioning the identified data product to the customer. The method may further include identifying proprietary data and private data of the data elements based on a predefined policy and removing proprietary data and private data before performing abstraction.

### CROSS REFERENCE TO RELATED APPLICATIONS

This application claims priority to U.S. Provisional Patent Application No. 63/650,299, filed on May 21, 2024, the disclosure of which is incorporated by reference in its entirety for all purposes.

### FIELD

The present disclosure generally relates to telecommunications systems and methods, and more specifically to a data abstraction layer of a wireless telecommunications network for keeping network data sources and the consumer associated with the data sources separate and away from tightly coupled pointed integrations.

### BACKGROUND OF THE DISCLOSURE

In current telecommunications systems, both mobile network operators (MNOs) and mobile virtual network operators (MVNOs) are challenged by the need to handle vast volumes of diverse data, particularly from the Fifth Generation (5G) wireless network. This diversity and volume, coupled with hyper-distributed functional architectures, significantly complicate the data collection process. Additionally, existing data management solutions like data warehouses, data lakes, and data meshes often result in siloed teams and systems but fail to provide a simplified, unified, and integrated view of trusted data in real-time.

### SUMMARY

Certain embodiments of the present disclosure may provide solutions to the problems and needs in the art that have not yet been fully identified, appreciated, or solved by current communications technologies, and/or provide a useful alternative thereto. For example, some embodiments of the present disclosure pertain to a tiered telecommunications system with one or more data abstraction layers.

In an embodiment, a telecommunications system for a network is provided. The telecommunications system includes an infrastructure layer, a data abstraction layer, and an interface layer. The infrastructure layer includes one or more network functions of the network and one or more data sources, the data sources are configured to collect and store raw data associated with the one or more network functions. The data abstraction layer includes one or more servers configured to retrieve the raw data from the data sources, perform abstraction on the raw data to generate one or more data products associated with the network functions, receive a customer request for a service on the network, identify the data product related to the service, and provision the identified data product to the customer via the interface layer.

In another embodiment, a method performed by a data abstraction layer of a telecommunications system for a network is provided. The method includes receiving raw data associated with one or more network functions of the network, performing abstraction on the raw data to generate one or more data products associated with the network functions, receiving a customer request for a service on the network, identify the data product related to the service, and provision the identified data product to the customer.

In yet another embodiment, a computer device or computer system is provided. In one example, the computer device or computer system includes: one or more processors and a computer-readable storage media storing computer-executable instructions. The computer-executable instructions, when executed by the one or more processors, cause the computer device or computer system to perform a method described in the present disclosure.

In yet another embodiment, a non-transitory machine-readable storage medium is provided. The non-transitory machine-readable storage medium is encoded with instructions, the instructions are executable to cause one or more electronic processors of a computer system or a computer device to perform any one of the methods described in the present disclosure.

### BRIEF DESCRIPTION OF THE DRAWINGS

In order that the advantages of certain embodiments of the disclosure will be readily understood, a more particular description of the disclosure briefly described above will be rendered by reference to specific embodiments that are illustrated in the appended drawings. While it should be understood that these drawings depict only typical embodiments of the disclosure and are not therefore to be considered to be limiting of its scope, the disclosure will be described and explained with additional specificity and detail through the use of the accompanying drawings, in which:

FIG. 1 is an architectural diagram illustrating a telecommunications product platform, according to various embodiments of the present disclosure.

FIG. 2 is an architectural diagram illustrating a telecommunications data management system, according to various embodiments of the present disclosure.

FIG. 3 is an architectural diagram illustrating a wireless communications system, according to various embodiments of the present disclosure.

FIG. 4 is a flow diagram illustrating a process for providing tiered telecommunications data management, according to various embodiments of the present disclosure.

FIG. 5A illustrates an example of a neural network for assisting with telecommunications data management, according to various embodiments of the present disclosure.

FIG. 5B illustrates an example of a neuron shown in FIG. 5A, according to various embodiments of the present disclosure.

FIG. 6 is a flow diagram illustrating an example pross for training AI/ML model(s), according to various embodiments of the present disclosure.

FIG. 7 is an architectural diagram illustrating a computing system configured for operation in a telecommunications data management system, according to various embodiments of the present disclosure.

FIG. 8 is a flow diagram illustrating an example method for provisioning data products, according to various embodiments of the present disclosure.

Unless otherwise indicated, similar reference characters denote corresponding features consistently throughout the attached drawings.

### DETAILED DESCRIPTION OF THE EMBODIMENTS

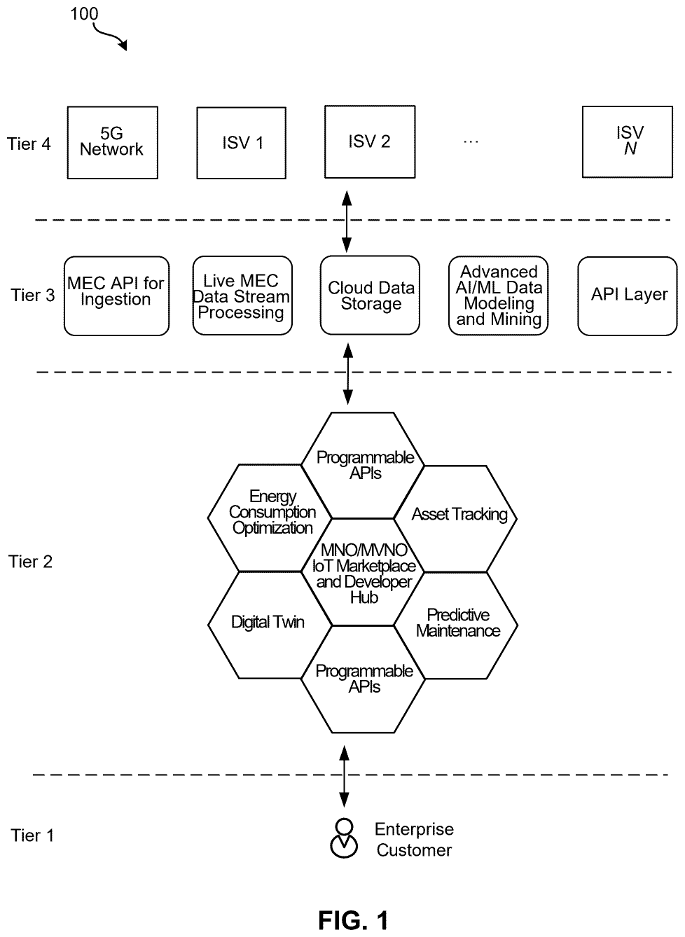

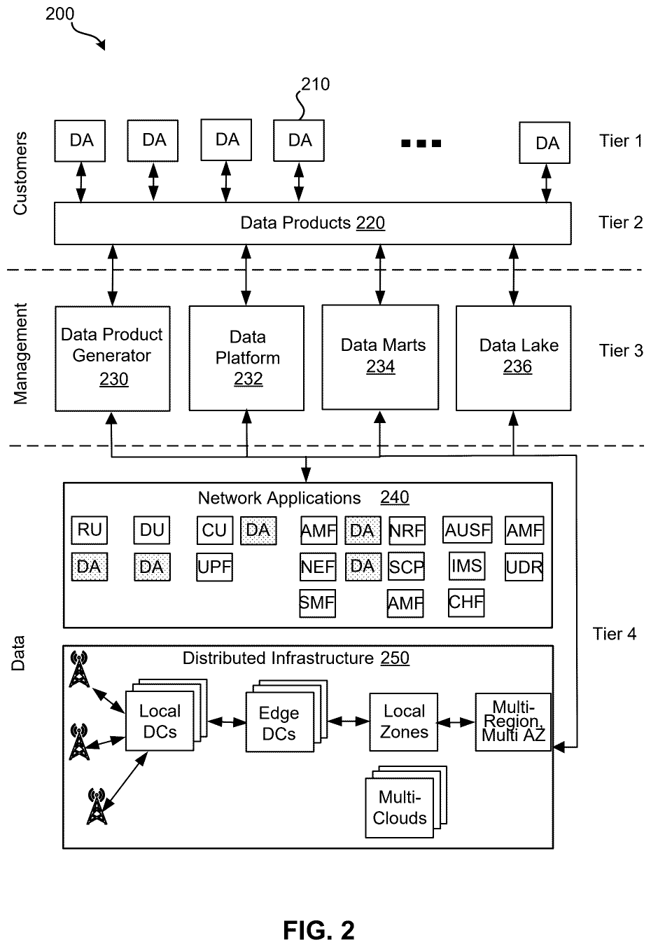

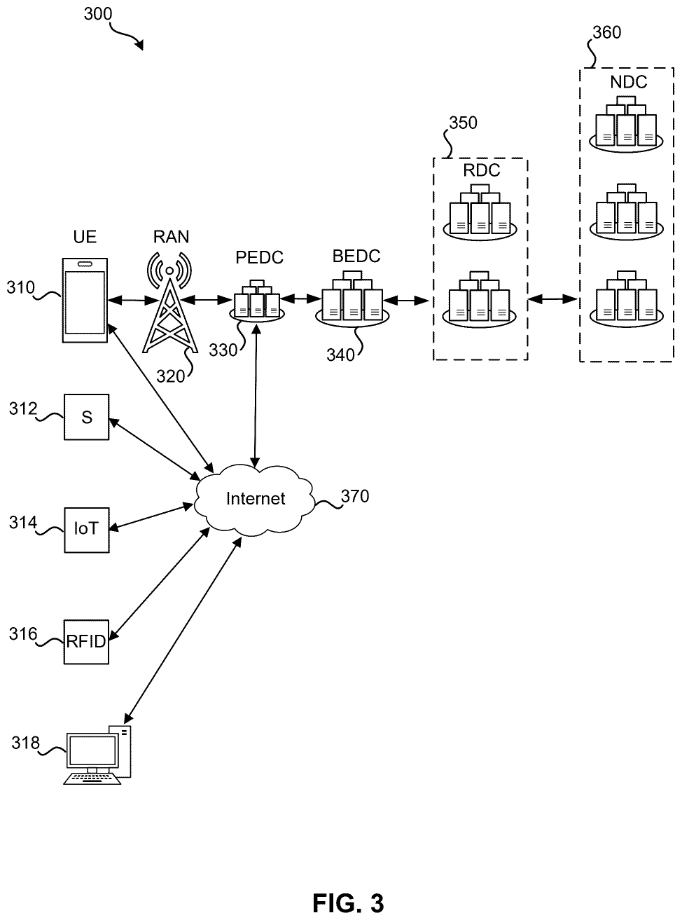

Various examples and embodiments of the telecommunication systems having one or more data abstraction layers are described below with references to FIGS. 1-3. FIG. 1 is an architectural diagram illustrating a high-level overview of an example telecommunication product enablement platform or system 100 (hereinafter “system 100”). Additional examples or variations of the system 100 are illustrated in FIGS. 2-3. In the illustrated example of FIG. 1, the system 100 has at least a first tier (i.e., Tier 1), a second tier (i.e., Tier 2), a third tier (i.e., Tier 3), and a fourth tier (i.e., Tier 4). Additional or fewer tiers may be included in the system 100. The terms “tier” or “layer” are used interchangeably here and refer to the physical or logical separation of hardware and/or software components designed to handle specific functionalities within a distributed communications system.

At a high level, Tier 1 is a customer layer, Tier 2 is an application/service layer, Tier 3 is a data abstraction layer, and Tier 4 is a data source provider layer. Tier 1 is the frontline interface for end-users and customers (e.g., enterprise customers). Tier 1 allows the customers to interact with the product enablement platform 100, typically through user interfaces or customer-specific applications/services. Tier 2 is generally responsible for hosting the actual applications and services that are provisioned to users, processing user requests, executing business logic, and delivering content or services as requested by the customers of Tier 1. Tier 3 serves as a data abstraction layer that manages access to data sourced from Tier 4, standardizes data types and formats, generates various data products, and provides a unified interface to Tier 2 and Tier 1. Tier 4 includes the underlying databases, data lakes, data warehouses, either external or internal, that store and manage all the data necessary for the operation of the tiered telecommunications system. Details of each tier are described below.

In some embodiments, Tier 4 is a wireless core network and may include network exposure functions (NEFs) and the Independent Software Vendors (ISVs) that constitute primary sources of data (i.e., data sources) in the wireless core network. One example of the wireless core network is a 5G core network provided by a core network provider. The primary purpose of NEFs is to securely expose the capabilities and services of the wireless network to authorized external applications and other networks. Tier 4 is the physical representation of the data that generated in or affiliated to the core network.

Examples of the NEFs include Short Messaging Service Center (SMSC) exposure via API for an internal network function. Mavenir is the ISV which manages the SMSC. Other examples of NEFs include Quality of Service (QOS) control, network slicing service, device capability exposure, etc. Tier 4 may further include other core network functions managed internally by the core network provider or externally by a network function vendor. Examples of the network functions are described below with reference to FIG. 2.

Tier 4 provides data sources that collect, generate, store, and manage various data elements. For example, various data elements associated with SMSC as a data source can be generated and stored, including but not limited to message content, sender/recipient information, timestamps, message status, service type, routing information, etc.

Tier 3 is a data abstraction layer for all the data elements of the data sources using a data mesh/platform approach. Tier 3 integrates various data sources with various native formats or storage solutions and provides a unified and simplified view of these data sources to higher tiers. Tier 3 may utilize various data virtualization techniques to provide real-time or near-real-time access to data without the need for physical loading into a data warehouse of Tier 4, and therefore enables more agile data processes. For example, application programming interfaces (API) may be generated, standardized, and exposed to enable different parts of the business to access and manipulate data seamlessly. Tier 3 further allows for the development of various plug-and-play modules, which can be integrated or replaced without impacting other components or Tiers of the telecommunications system. Data as a Service (DaaS) techniques may also be used to turn data management into a service-oriented model, where data delivery and processing are abstracted as services that can be consumed by the consumers of Tier 1. In some embodiments, Tier 3 also facilitates the use of artificial intelligence and/or machine learning (AI/ML) models, whether developed internally within the network provider or externally by the ISVs. The AI/ML models can leverage both historical and real-time data curated by Tier 3 to facilitate the productization of data elements as well as standardization and modulation of data abstraction.

One example of the data abstraction components within Tier 3 is cloud data storage, such as Amazon S3. Tier 3 can be configured to abstract the details of cloud storage and present a straightforward data access interface to Tier 2 (i.e., the application layer). Another example of the data abstraction components within Tier 3 is the live mobile edge computing (MEC) data stream (e.g., provided by an ISV). This component can be configured to integrate with streaming data platforms to handle real-time data flows from MEC sources.

Tier 2 serves as a gateway that exposes services, data products, and APIs developed and managed in Tier 3 to external customers of Tier 1. Tier 2 also provides an interface that allows external customers to interact with the system 100. Example components of Tier 2 includes MVNOs, end users, public and private customers of the network, API developers, Application-to-Person (A2P) aggregators, etc.

According to the present disclosure, the telecommunications system with one or more tiered data abstraction layers, as described herein, provides at least the following advantages. The abstraction layer provides data management on top of a data architecture, avoids direct, pointed integrations by customers to physical sources, and enables plug-and-play models for telecommunications-related data usage and productization. Being able to select from a suite of standardized/formalized data products provides speed in enablement of 5G services to create dynamic, stateless solutions without physical data sources or systems attached thereto. The data abstraction layer also allows for the separation of the data from the functionality and provides plug-and-play service capabilities with data in a similar manner to network services.

A data product used herein may refer to a software application or tool that encapsulates data and the processes necessary to collect, store, process, and present it in a structured and useful format to customers. end users, or other systems. The data products are designed to provide specific functionality and value by abstracting complex data operations and making data more accessible and actionable. A data product can include various components for data ingestion, data transformation, data storage, data querying, data visualization or interaction, among others.

Moreover, because of the abstraction layer, customers from Tier 1 do not get to the actual physical layer of the MNO, which is essentially “behind a wall.” The MNO pulls from large data sources and provides customers with “abstracts” of information. The customer can consume this data, but does not need to prepare the data from scratch. Using such an approach, MNOs can provide data services that meet evolving 5G network needs. The data products are generally abstractions of the data below and could include APIs, prepared datasets with names (e.g., traffic data for Short Message Service (SMS)); web interfaces that customers can select certain types of data from and configure the information that is desired, data feeds, data analytics tools, recommendation engines, etc.

The abstraction layer may be in a suitable templatized format around the tiers, which can be well-defined. A layer may be leveraged across different functional groups within an organization where each functional group owns the data, but it is not flowing through a chain of command. A front end portal may have a query engine, but the data products may appear as little icons that users can drill down into and drag and drop into a canvas.

Some embodiments may be used for source isolation, access method isolation, permissions management security, data version management, and quality, for example. However, such embodiments may also handle use cases that do not yet exist. In other words, some embodiments provide a declarative method of obtaining data, which means that the owner of the data defines how the data should be managed for the end consumer, but the end consumer will not have insight into the data management. The amount of data for MNOs grows very quickly, and such embodiments make the data more manageable for consumers. Such embodiments also allow MNOs to take advantage of data that has unrealized value and is not initially known.

In some embodiments, AI/ML models may be produced to provide a consistent data layer that is abstracted from the physical layer. Such AI/ML models may be beneficial for templatizing and automation, for example. For instance, AI/ML models may dictate what data to abstract and how. The AI/ML models could observe what customers are building/requesting and suggest common functionality to other customers. In some embodiments, AI/ML may sit on every tier, such as those shown in FIG. 2 and discussed in detail below.

AI can thus learn where value is in the data products and figure out what is actually being used. AI could also be used to propose, define, formalize, standardize, and refine the data products. Large language models (LLMs) may be able to observe operational sources and/or consumer interactions and could help with increasing reuse of microservices.

FIG. 2 is an architectural diagram illustrating a telecommunications data management system 200 (hereinafter “system 200”), according to an embodiment of the present disclosure. System 200 represents a variation of system 100, specifically for 5G network deployed on a cloud-computing platform. System 200 includes at least a first tier (i.e., Tier 1), a second tier (i.e., Tier 2), a third tier (i.e., Tier 3), and a fourth tier (i.e., Tier 4). Additional or fewer tiers may be included in the system 200.

Tier 1 includes data applications (DAs) 210. DAs 210 represent customers that consume the data products generated in the system 200. In some embodiments, DA 210 may be a data processing microservice or agent. More broadly, the DA 210 may be a server or a service operated by enterprise and wholesale end users, such as operations managers, information technology (IT) managers, procurement managers, and executives of large manufacturing companies, warehouse operators, wholesale distributors, MVNOs, other vendors in manufacturing and warehouse verticals, etc. DAs 210 rely on the telecommunications data management system 200 to access various services, solutions, and data products.

Data integration for customers using current systems is complex. Enterprises may struggle with integrating data from multiple sources and systems, hindering their ability to derive meaningful insights. A lack of customization may also present a problem. Enterprises often require tailored solutions that align with their specific industry requirements, making off-the-shelf offerings less effective. Furthermore, data security and privacy can be an issue with existing solutions. These are critical concerns for enterprise customers, particularly when sharing sensitive operational data with external platforms. Also, improper sharing of this data, or the data being improperly obtained by a malicious actor, may run afoul of the E.U. General Data Protection Regulation (GDPR), the U.S. Health Insurance Portability and Accountability Act (HIPAA), third party terms of service, other contractual obligations, corporate policies, etc.

Tier 2 includes data products 220. In some embodiments, data product 220 can be a service or application, for example, Multi-Access Edge Computing (MEC) services, enabling services such as bring your own (BYO) services, etc., which are accessible by customers. As mentioned above, Tier 2 serves as a marketplace where a company can showcase and sell its services, product offerings, and product enablement. Customers can browse and select from a range of available solutions and data products that cater to their specific needs. The marketplace acts as a bridge between Tier 1 and Tier 3, and is an online platform owned by the MNO, where services, solutions, and data products are showcased and made available for purchase. Enterprise customers and wholesale customers can search for suitable offerings to enhance their operations. Data products 220 should be readily discoverable and easy to navigate through, build customer trust in the marketplace and provide reliable services and solutions, and clearly communicate pricing models, licensing agreements, and any associated costs to potential customers.

Tier 3 serves as the abstraction layer between Tier 2 and Tier 4. Tier 3 provides a combination of solutions and services, such as network services, data services, and data environments. “Solutions” are holistic plug-and-play modules to construct a service. Tier 3 also provides a logical, usable data layer with operational and derived data products. In the illustrated example, Tier 3 includes data product generator 230, data platform 232, data marts 234, and data lake 236. The data product generator 230 is operable and configured to generate various data products (e.g., enterprise data products). Examples of the enterprise data products include metadata-based logical data design, data APIs, correlations. The data product generator 230 is operable to transform raw data (e.g., data elements from Tier 4) into structured, formalized, and standardized data products, which can be directly consumable or integrated into applications and services provisioned to the customer. The metadata-based logical data designs can be used to organize and describe the structure of data in an understandable format, the data APIs provide interfaces to access or manipulate data, and the correlations can identify relationships between different data points within a data product or across different data products.

Data platform 232 includes data ontology, data access, catalogs, inventory, monitoring, data audits, deployment, etc. Data product generator 230 and data platform 232 provide centralized data monitoring and data obfuscation. Data product generator 230 and data platform 232 also provide role-based access control (RBAC) and data visibility and facilitate deployment.

Data marts 234 provide data warehouses focused on a single subject or line of business. Data lake 236 provides centralized physical data. Data marts 234 and data lake 236 provide centralized data processing, centralized data storage, and centralized data monitoring and controls.

Tier 3 may also provide various MNO services, such as network connectivity services, data analytics services, real-time monitoring services, security services, etc. These services form the foundation for the solutions offered to enterprise clients in Tier 1. Solutions are comprehensive packages that leverage the services provided in Tier 3. They are tailored to specific verticals, such as manufacturing and warehousing. Solutions can include features such as predictive maintenance, inventory management, supply chain optimization, asset tracking, and other industry-specific functionality.

Tier 3 also provides a logical data layer that acts as the central repository for data generated and processed within system 200. The logical data layer encompasses data storage, data processing, and data integration capabilities and enables the aggregation, transformation, and analysis of data from various sources, including the physical layer of Tier 4, to derive valuable insights. Some examples of services include, but are not limited to, providing network connectivity, data analytics, real-time monitoring, security, predictive maintenance, inventory management, supply chain optimization, asset tracking, etc. Some example solutions include, but are not limited to, a comprehensive Industry 4.0 solution for manufacturing process optimization, a warehouse management system, a real-time inventory tracking solution, etc. The logical data layer provides data storage infrastructure, data processing engines, data integration tools, data governance frameworks, etc. for data scientists, solution architects, data engineers, IT administrators, business analysts, and others.

Tier 3 also provides scalability by ensuring that the services, solutions, and data layer can handle large volumes of data and support the growing needs of enterprise clients. Tier 3 also provides good data quality and consistency by maintaining data accuracy, completeness, and consistency across different sources and ensuring reliable data processing and analytics. Tier 3 further provides flexibility and adaptability and offers customizable and flexible solutions that can be readily integrated into diverse manufacturing and warehouse environments.

Tier 4 is the physical layer and provides the primary source of data. Specifically, the physical layer represents the infrastructure and devices that generate the data. For MNOs, this can include the 5G network infrastructure, Internet-of-Things (IoT) devices, sensors, radio frequency identifier (RFID) tags, and other connected devices deployed in manufacturing and warehouse environments, for example. Tier 4 collects and transmits real-time data, such as machine sensor readings, inventory levels, equipment status, etc., which are then processed and utilized by the logical data layer of Tier 3 to provide data-driven solutions and offerings. This information may be used by operations technicians, IoT engineers, network administrators, and maintenance personnel responsible for managing and maintaining the physical infrastructure, for example.

Tier 4 facilitates device compatibility and interoperability by ensuring seamless integration and communication between different devices, protocols, and systems deployed in the physical environment. Tier 4 also provides data security and privacy by implementing robust security measures to protect sensitive data transmitted over the network and stored on devices. Tier 4 further provides straightforward maintenance and effective monitoring by proactively monitoring the health and performance of devices to prevent failures and ensure uninterrupted data flow.

Tier 4 may include various network applications 240 (sometimes also referred to as network functionalities or network functions (NFs)) and a distributed infrastructure 250. The NFs can generate various data elements such as transactional data and data sidecar services and provide the data elements to Tier 3. Examples of NFs include but are not limited to Radio Units (RUs), Central Units (CUs), User Plane Function (UPF), Short Message Service Function (SMSF or SMF), Unified Data Repository (UDR), Network Exposure Function (NEF), Network Repository Function (NRF), Service Communication Proxy (SCP), Access and Mobility Management Function (AMF), Authentication Server Function (AUSF), Internet Protocol (IP) Multimedia Subsystem (IMS), Charging Function (CHF), and Unified Data Repository (UDR) function. Distributed infrastructure 250 includes the physical components of the telecommunications system. These include radio access networks (RANs), satellites, Internet hardware, a cloud computing platform including local data centers (DCs), edge DCs, local zones, regions, availability zones (multi-AZ), and private/public clouds.

Tier 1 depends on Tier 2 for accessing and procuring the services, solutions, and data products offered by the network provider or the operator of the core network. Tier 2 relies on Tier 1 as its primary customer base and source of revenue. Tier 3 relies on Tier 2 for showcasing and promoting its services and solutions to customers. Tier 3 also interacts with Tier 4 to collect and process data for deriving insights. Tier 4 acts as the primary source of data for the entire data platform. Tier 4 provides real-time data to Tier 3 for analysis and processing, enabling the creation of valuable data-driven solutions and offerings.

Overall, this four-tiered approach allows MNOs to provide end-to-end data platform and data-products capabilities, from infrastructure to data analytics. This enables the delivery of customized services, solutions, and data products to enterprise clients such as manufacturing, warehouses, ports, etc. By abstraction via Tier 3, direct, pointed integrations to physical sources are avoided and abstraction layers are created to enable plug-and-play models for telecommunications-related data usage and productization. Customers can select from a suite of solutions that provide rapid enablement of 5G services to create dynamic solutions. These are stateless solutions without data attached thereto. The goal of some embodiments is to separate the data from the functionality and provide plug-and-play capabilities with data, as with service functionality. Teams and subject matter experts (SMEs) from various domains can own and provide the data as a product for the plug-and-play model, which includes the publishing methods and integration methods that are not yet known in the telecommunications industry.

With 5G, new avenues to harness data from various sources are available via software-based microservices. Critical aspects of data management, such as security, quality, and accessibility, are primary blockers for speed and consumption of data. With data products abstractions, functional teams can declare these aspects rather than having the end consumers manage them.

Data products are owned and have a defined data management service level agreement (SLA) commitment from the sources. This takes away the overall lag in time from the end consumer for data preprocessing. These aspects bring down the cost of delivering data as they will be owned and managed by domains, thus removing redundant data cleaning processes and establishing data trust inherent to the product itself. This is unique to the 5G wireless business and can increase profit margins of MNO services. Because data preprocessing can be a significant cost burden for every organization, the data abstraction layer described herein can mitigate the cost and increase profitability for services that have marginal price points.

Per the above, various services are offered by the tiered system of some embodiments, such as A2P messaging, location services, testing as a service, topology explorers, data analytics services, and security services. The following use cases provide non-limiting examples of these above services.

One use case is related to A2P messaging service. In some embodiments, Tier 1 offers A2P messaging bundles to customers, Tier 2 includes A2P messaging APIs in the marketplace for third-party developers, Tier 3 provides modular A2P messaging solutions and/or operational data products that can be customized according to business needs, and Tier 4 provides the actual SMS gateway and infrastructure. Operational data products may include SMS traffic data and delivery reports. SMS traffic data may include real-time data pertaining to the volume of SMS messages sent and received, which can be used for network optimization and capacity planning. Delivery reports may include status reports on message delivery, such as for customer service and troubleshooting purposes. Derived data products may include user engagement metrics, which are derived from user behavior, such as response rates, peak usage times. These can be used for targeted marketing and service improvement, for example.

Another use case is related to location service. In some embodiments, Tier 1 offers location-based services to consumers, such as “Find My Phone,” Tier 2 sells location APIs in the marketplace, Tier 3 provides location analytics solutions that businesses can plug into their existing systems, and Tier 4 provides actual location data from cell towers and user devices. Operational data products may include real time tracking of device locations, such as for emergency services and customer support purposes. Derived data products may include location analytics, such as aggregated data pertaining to user locations to identify patterns for network planning and targeted advertising purposes.

Another use case is related to testing service. In some embodiments, Tier 1 is mostly an enterprise service, Tier 2 offers testing services via the marketplace, Tier 3 provides pre-built testing modules for network latency, speed, and reliability, and Tier 4 provides test data and network logs. Operational data products may include network performance logs, which are raw logs of network performance metrics that can be used for network optimization, for example. Derived data products may include quality of service metrics, which are derived from network performance logs and can be used for SLA compliance and customer reports, for example.

Another use case is related to topology exploration service. In some embodiments, Tier 1 offers a simplified network topology view to consumers for better understanding of network coverage, Tier 2 sells topology exploration APIs to third-party developers, Tier 3 provides complete topology solutions that can be integrated into network management systems, and Tier 4 provides the actual network topology data. Operational data products may include network topology maps, which are real time graphical representations of network infrastructure that can be used for network management, for example. Derived data products may include network health indicators, which are metrics derived from topology data that indicate network health and can be used for predictive maintenance and capacity planning, for example.

Another use case is related to data analytics services. In some embodiments, Tier 1 offers consumer-facing analytics services like data usage breakdown, call analytics, etc., Tier 2 provides API-based analytics services in the marketplace, Tier 3 provides customizable analytics modules, and Tier 4 provides raw data from various data sources that feed into the analytics. Another use case is related to security services. In some embodiments, Tier 1 offers consumer-level security services, such as antivirus protection, firewalls, etc., Tier 2 provides security APIs for third-party developers, Tier 3 provides enterprise-level security solutions, and Tier 4 provides raw security logs and threat intelligence data.

Various other operational and derived services may also be provided, such as 5G network slicing, predictive network analyzers, network continuous integration and continuous deployment (CI/CD) configurations, billing as a service (BaaS), dataflow sentries, and Simple Provisioning Service (SPS). For 5G network slicing, operational data products may include slice allocation data, which is real time data pertaining to the allocation of network slices to various services for immediate resource allocation and network optimization, for example. Operational data products may also include slice performance metrics, which is real time performance data of each network slice and can be used for monitoring and managing each slice, for example. Derived data products may include slice utilization reports, which are aggregated reports showing the utilization of each slice over time and can be used for long-term resource planning and billing, for example.

For predictive network analyzers, operational data products may include anomaly detection logs, which are logs of detected network anomalies and can be used for immediate troubleshooting and root cause analysis, for example, and derived data products may include root cause analysis reports, which are reports identifying the root causes of detected anomalies that can be used for network improvement and preventative measures, for example. For network CI/CD configurations, operational data products may include configuration logs of configuration changes in the network that can be used for audit trails and rollback, for example, and derived data products may include change impact metrics, which are metrics showing the impact of configuration changes on network performance and can be used for evaluating the success of configuration changes, for example. For BaaS, operational data products may include billing records of raw billing data for services that can be used for immediate billing and dispute resolution, for example, and derived data products may include revenue analytics on revenue generated from various services that can be used for strategic planning and marketing, for example. For dataflow sentries, operational data products may include logs of firewall activities that can be used for security monitoring and immediate threat response, for example, and derived data products may include threat intelligence reports, which are aggregated and analyzed data on potential security threats that can be used for long-term security planning and preventative measures, for example. For SPS, operational data products may include provisioning logs of provisioning activities for network resources for audit trails and immediate resource allocation, for example, and derived data products may include resource utilization reports, which are aggregated reports on how provisioned resources are being utilized that can be used for resource planning and cost optimization, for example.

It should be noted that the above provided use case examples are not limiting. For example, the initial set of data products derived directly from operational data sources may represent the core, raw data that has been minimally processed. These baseline data products serve as the foundational layer upon which additional value-added analytics and data products can be built. Higher tiers can utilize these baseline data products to derive more complex and correlated data products. Examples may include extracting insights, recognizing patterns, and making connections between different data points. In other words, in a tiered data abstraction architecture, each tier builds upon the lower tiers and the architecture progressively adds complexity and value to the initial data inputs.

FIG. 3 is an architectural diagram illustrating a wireless communications system 300 (hereinafter “system 300”), according to various embodiments of the present disclosure. In the illustrated example, system 300 includes User equipment (UE) 310, sensors 312, IoT devices 314, RFID tags 316, customer computer 318, radio access network (RAN) 320, pass-through edge data center (PEDC) 330, breakout edge data center (BEDC) 340, reginal data center 350, and national data center 360, and Internet 370. Fewer or additional components may be included in system 300. Various components of system 300 may be communicatively coupled via RAN 320 and/or Internet 370.

UE 310 may be a mobile phone, a tablet, a laptop computer, etc., in communication with radio access network (RAN) 320 as well as Internet 370. Sensors 312, IoT devices 314, RFID tags 316, and customer computer 318 are in communication with Internet 370. In some embodiments, one or more of sensors 312, IoT devices 314, RFID tags 316, and/or customer computer 318 may additionally or alternatively communicate via RAN 320.

RAN 320 sends communications to UE 310, as well as from UE 310 further into the carrier network. In some embodiments, communications are sent to/from RAN 320 via PEDC 330 and BEDC 340 to provide lower latency. In some embodiments, RAN 320 communicates directly with BEDC 340. BEDCs 340 are typically smaller data centers that are proximate to the populations they serve. BEDCs 340 may break out User Plane Function data traffic (UPF-d) and provide cloud computing resources and cached content to UE 310, such as providing NF application services for gaming, enterprise applications, etc.

The carrier network may provide various NFs and other services. For instance, BEDC 340 may break out UPF-d and provide cloud computing resources and cached content to mobile device 310, such as providing NF application services for gaming, enterprise applications, etc. RDC 350 may provide core network functions, such as UPF for voice traffic (UPF-v) and SMSF function. NDC 360 may provide a UDR and user verification services, for example. Other network services that may be provided may include, but are not limited to, IMS+telephone answering service (TAS) function, IP-SM gateway (IP-SM-GW) function (the network function that provides the messaging service in the IMS network), enhanced serving mobile location center (E-SMLC) function, policy and charging rules function (PCRF) function, mobility management entity (MME) function, signaling gateway (SGW) control plane (SGW-C) and user data plane (SGW-U) ingress and egress point function, packet data network gateway (PGW) control plane (PGW-C) and user data plane (PGW-U) ingress and egress point function, home subscriber server (HSS) function, UPF+PGW-U function, AMF, HSS+unified data management (UDM) function, SMF+PGW-C function, short message service center (SMSC) function, and/or policy control function (PCF) function. It should be noted that additional and/or different network function may be provided without deviating from the present disclosure. The various functions in these systems may be performed using dockerized clusters in some embodiments.

BEDC 340 may utilize other data centers for NF authentication services. A regional data center (RDC) 350 receives NF authentication requests from BEDC 340. RDC 350 may provide core network functions, such as UPF-v and SMSF. This helps with managing user traffic latency, for instance. In some embodiments, RDC 350 may not perform NF authentication.

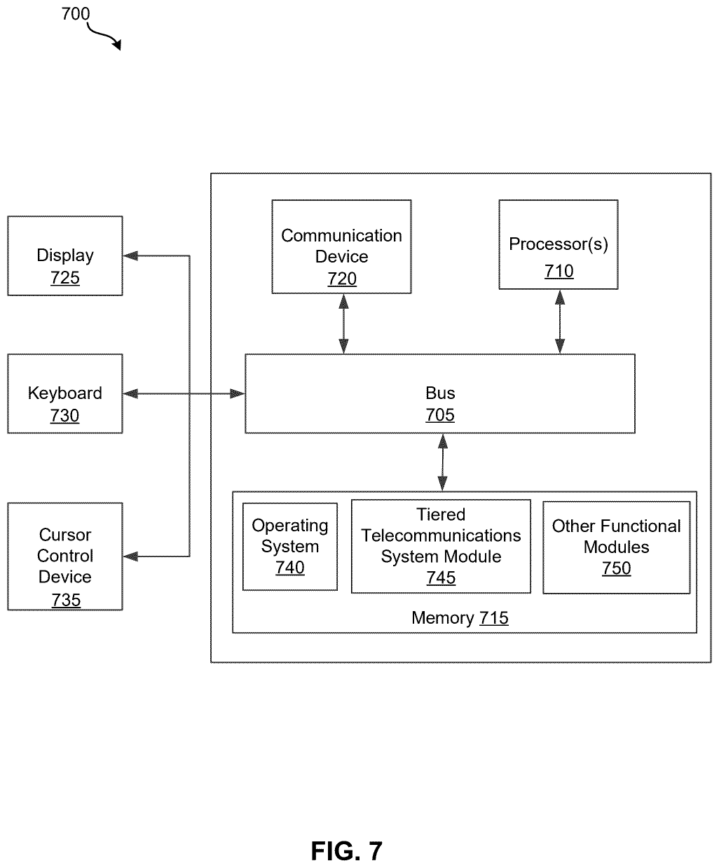

From RDC 350, NF authentication requests may be sent to NDC 360, which may be located far away from UE 310, RAN 320, PEDC 330, BEDC 340, and RDC 350. NDC 360 may provide a UDR, and user verification may be performed at NDC 360. UPF-d, UPF-v, SMSF, UDR, and user verification may be performed by dockerized computing clusters. Once the user of UE 310 is verified and authorized hardware is confirmed via NDC 360, NF authentication is completed by UE 310 and the NF is authorized. UE 310 is then able to access and use the respective application or service via PEDC 330 or BEDC 340. In some embodiments, mobile device 310 and/or computing systems of RAN 320, PEDC 330, BEDC 340, RDC 350, and/or NDC 360 may be computing system 700 of FIG. 7.

Carrier network data may be stored on computing systems of PEDC 330, BEDC 340, RDC 350, and/or NDC 360. These computing systems may also host the logic associated with the abstraction layer (e.g., Tier 3 of telecommunications data management system 200 of FIG. 2). The abstraction layer may provide network connectivity services, data analytics services, real-time monitoring services, security services, etc. The abstraction layer provides a logical data layer that acts as the central repository for data generated and processed within the system. The logical data layer encompasses data storage, data processing, and data integration capabilities and enables the aggregation, transformation, and analysis of data from various sources, including the physical equipment of FIG. 3, to derive valuable insights.

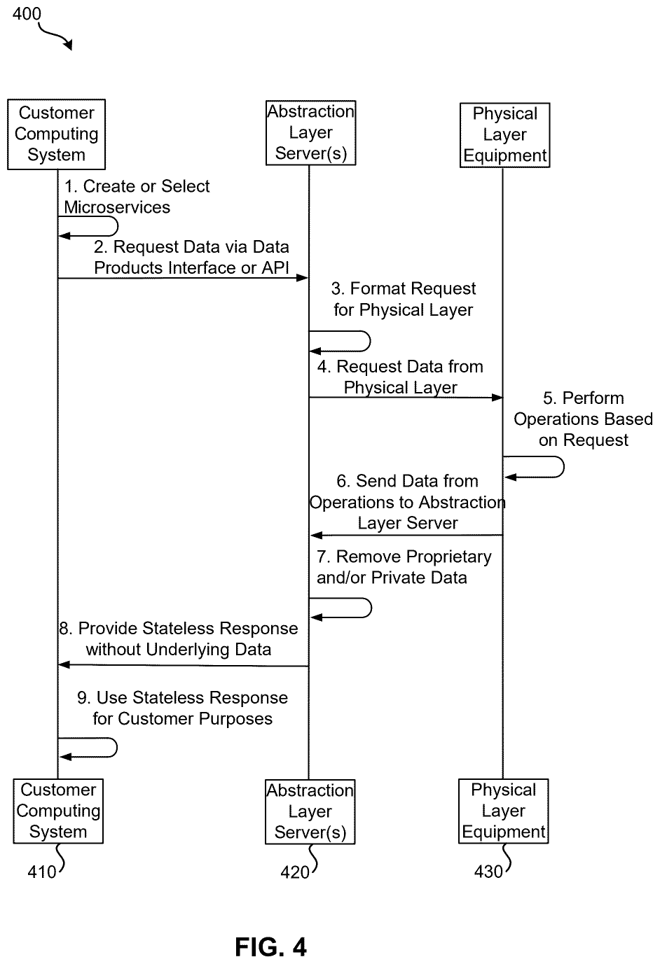

FIG. 4 is a flow diagram illustrating a process 400 for providing telecommunication data management via a customer computing system 410, abstraction layer server(s) 420 (e.g., Tier 3 servers), and physical layer equipment 430 (e.g., Tier 4 computing systems and telecommunications hardware and electronics), according to some embodiments of the present disclosure. Customer computing system 410 may be a mobile device, a tablet, a laptop computer, a desktop computer, etc. In some embodiments, customer computing system 410, abstraction layer server(s) 420, and/or computing systems of physical layer equipment 430 may be computing system 700 of FIG. 7.

A customer creates or selects microservices, if already created, via customer computing system 410. For instance, the customer may create or select existing microservices that provide network connectivity services, data analytics services, real-time monitoring services, security services, etc. The customer, via customer computing system 410, then requests data for a given microservice from abstraction layer server(s) 420 using a data products interface (e.g., a custom software application, a web interface, etc.), an API, etc.

Abstraction layer server(s) 420 format the request from customer computing system 410 into a format suitable for processing by physical layer equipment 430. Abstraction layer server(s) 420 then request the data associated with the microservice request from physical layer equipment 430. Physical layer equipment 430 performs operations based on the request from abstraction layer server(s) 420 (e.g., obtaining network traffic information, connectivity data, analytics data from AI/ML models, etc.) and sends the data from these operations to abstraction layer server(s) 420.

Abstraction layer server(s) 420 may remove proprietary and/or private data that the MNO does not wish to provide to the customer. For instance, information not permitted by law, policy, and/or contractual agreements may be removed. A stateless response without the underlying data is then provided to customer computing system 410. The stateless response is generated from an application sent after the request is taken, processed, and returned without persisting any data in the application. The customer can then use this response information for his or her desired purposes.

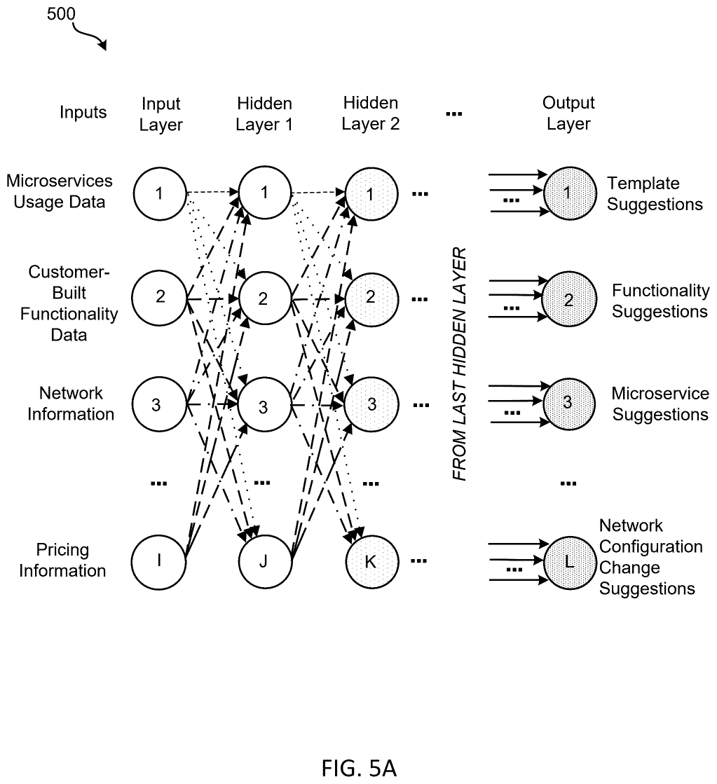

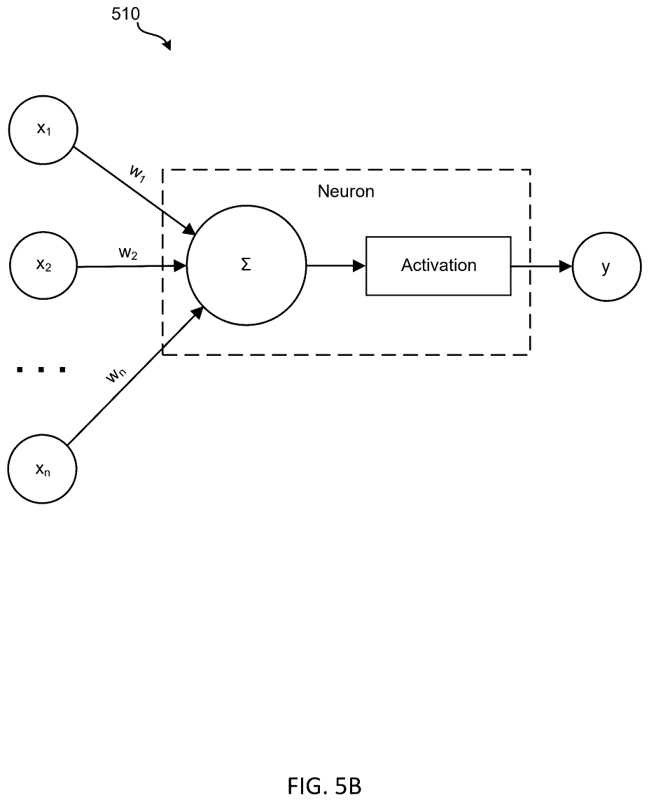

Per the above, AI/ML may be used for tiered telecommunications data management in some embodiments. Various types of AI/ML models may be trained and deployed without deviating from the scope of the disclosure. For instance, FIG. 5A illustrates an example of a neural network 500 that has been trained to assist with tiered telecommunications data management, according to an embodiment of the present disclosure.

Neural network 500 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 500.

A DLNN often has many layers (e.g., 10, 50, 200, etc.) and subsequent layers typically reuse features from previous layers to compute more complex, general functions. An SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 5A, microservices usage data (e.g., what microservices are being used and how often), customer-built functionality data (e.g., what common microservice functionality are customers tending to build), network information (e.g., congestion information, connectivity information, coverage maps, planned network expansions, etc.), pricing information (e.g., what microservices are users purchasing and for how much), etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the disclosure.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 500 without deviating from the scope of the disclosure. Indeed, in certain embodiments, the types of neurons in a given layer may not all be the same. For instance, convolutional neurons, recurrent neurons, and/or transformer neurons may be used.

Neural network 500 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 510 is shown in FIG. 5B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 & if \sum wx + bias \geq 0 \\ 0 & if \sum wx + bias < 0\end{matrix} \qquad ( 2 )$$

The output y of neuron 510 may thus be given by:

$$y = f ( x ) {\sum }_{i = 1}^{m} ( {w}_{i} {x}_{i} ) + bias \qquad ( 3 )$$

In this case, neuron 510 is a single-layer perceptron. However, any suitable neuron type or combination of neuron types may be used without deviating from the scope of the disclosure. It should also be noted that the ranges of values of the weights and/or the output value(s) of the activation function may differ in some embodiments without deviating from the scope of the disclosure.

A goal, or “reward function,” is often employed. A reward function explores intermediate transitions and steps with both short-term and long-term rewards to guide the search of a state space and attempt to achieve a goal (e.g., finding the best core for a give service or application, determining when a network associated with a core is likely to be congested, etc.).

During training, various labeled data is fed through neural network 500. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ηᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - I} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ′ denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the disclosure. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

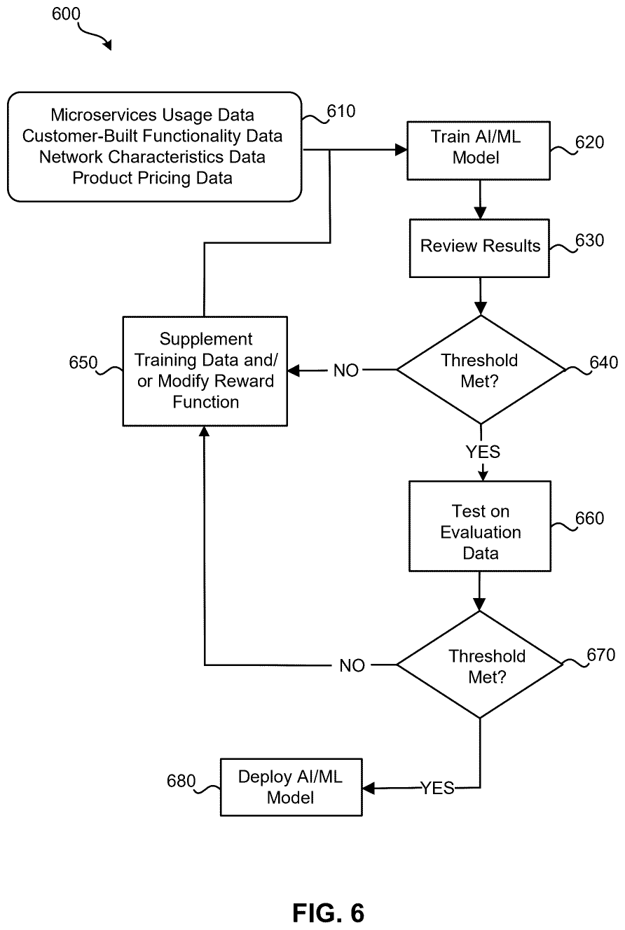

FIG. 6 is a flowchart illustrating a process 600 for training AI/ML model(s), according to some embodiments of the present disclosure. The process 600 begins with providing microservices usage data, customer-built functionality data, network characteristics data, product pricing data, etc. at 610, whether labeled or unlabeled. Other training data used in addition to or in lieu of the training data shown in FIG. 6. Indeed, the nature of the training data that is provided will depend on the objective that the AI/ML model is intended to achieve. The AI/ML model is then trained over multiple epochs at 620 and results are reviewed at 630.

If the AI/ML model fails to meet a desired confidence threshold at 640, the training data is supplemented and/or the reward function is modified to help the AI/ML model achieve its objectives better at 650 and the process returns to step 620. If the AI/ML model meets the confidence threshold at 640, the AI/ML model is tested on evaluation data at 660 to ensure that the AI/ML model generalizes well and that the AI/ML model is not overfit with respect to the training data. The evaluation data includes information that the AI/ML model has not processed before. If the confidence threshold is met at 670 for the evaluation data, the AI/ML model is deployed at 680. If not, the process returns to step 650 and the AI/ML model is trained further.

FIG. 7 is an architectural diagram illustrating a computing system 700 configured for operation in a tiered telecommunications data management system, according to an embodiment of the present disclosure. In some embodiments, computing system 700 may be one or more of the computing systems depicted and/or described herein, such as a mobile device, an abstraction layer server, a physical layer server, another carrier network server, a computing system of a RAN, etc. Computing system 700 includes a bus 705 or other communication mechanism for communicating information, and processor(s) 710 coupled to bus 705 for processing information. Processor(s) 710 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 710 may also have multiple processing cores, and at least some of the cores may be configured to perform specific functions. Multi-parallel processing may be used in some embodiments. In certain embodiments, at least one of processor(s) 710 may be a neuromorphic circuit that includes processing elements that mimic biological neurons. In some embodiments, neuromorphic circuits may not require the typical components of a Von Neumann computing architecture.

Computing system 700 further includes a memory 715 for storing information and instructions to be executed by processor(s) 710. Memory 715 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 710 and may include volatile media, non-volatile media, or both. The media may also be removable, non-removable, or both.

Additionally, computing system 700 includes a communication device 720, such as a transceiver, to provide access to a communications network via a wireless and/or wired connection. In some embodiments, communication device 720 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the disclosure. In some embodiments, communication device 720 may include one or more antennas that are singular, arrayed, phased, switched, beamforming, beamsteering, a combination thereof, and or any other antenna configuration without deviating from the scope of the disclosure.

Processor(s) 710 are further coupled via bus 705 to a display 725, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 725 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the disclosure.

A keyboard 730 and a cursor control device 735, such as a computer mouse, a touchpad, etc., are further coupled to bus 705 to enable a user to interface with computing system 700. However, in certain embodiments, a physical keyboard and mouse may not be present, and the user may interact with the device solely through display 725 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 715 stores software modules that provide functionality when executed by processor(s) 710. The modules include an operating system 740 for computing system 700. The modules further include a tiered telecommunications system module 745 that is configured to perform all or part of the processes described herein or derivatives thereof. Computing system 700 may include one or more additional functional modules 750 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the disclosure. Presenting the above-described functions as being performed by a “system” is not intended to limit the scope of the present disclosure in any way, but is intended to provide one example of the many embodiments of the present disclosure. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the disclosure.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the disclosure.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

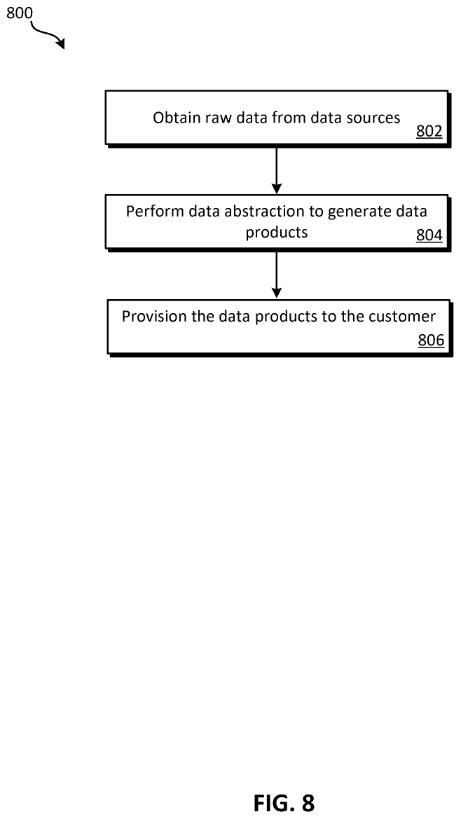

FIG. 8 is a flowchart illustrating a method 800 for provisioning data products to customers of a telecommunications network, according to some embodiments of the present disclosure. Method 800 may be performed by a telecommunications system having one or more data abstraction layers, such as system 100 or 200 or any component thereof, as described herein.

At 802, raw data is obtained from data sources of a telecommunications network such as a 5G network and received in a data abstraction server in communication with the 5G network. The 5G network includes various network functions. In some embodiments, the 5G network is deployed on a cloud-computing platform having a physical infrastructure. The physical infrastructure can include various data centers and data sources. The raw data encompasses data elements (e.g., raw data) generated in the network functions of the 5G network as well as correlated data generated in the infrastructure. The data elements are stored in the data sources of the infrastructure.

At 804, data abstraction process is performed by the data abstraction system included in the data abstraction layer to transform the raw data into data products that are accessible and consumable by the customer of the 5G network. In some embodiments, the data abstraction process may further include determining/identifying unnecessary or redundant data elements based on predefined criteria relevant to the intended use cases of the data products, filtering the unnecessary or redundant data elements, normalization to standardize data formats and scales to facilitate interoperability among different types of raw data, aggregation to compile data from multiple data sources according to a pre-determined data structure, and transformation to convert data into formats suitable for further analysis and accessible by the consumers.

In some embodiments, the data abstraction process further includes removing proprietary and/or private data. For example, the data elements are classified based on predefined criteria specifying a proprietary level or a sensitive level. Data elements such as customer names, addresses, and payment information can be classified as private, trade secrets or internal algorithms can be classified as proprietary. Relevant regulatory requirements that govern the handling of proprietary and private data are identified, and data protection policies are established to define how proprietary and private data should be handled, including access controls, encryption, and anonymization. Data scrubbing can be performed to remove or mask proprietary and private data elements. For example, sensitive information from text fields can be redacted, sensitive data can be replaced with placeholder characters or by masking, and sensitive data can be tokenized or replaced with a non-sensitive equivalent that can be mapped back to the original data. In some embodiments, generalization can be performed to replace specific data values with broader categories, suppression can be performed to remove records or fields that contain sensitive data elements that are not essential for the intended analysis, perturbation can be performed to add random noise to data elements to mask sensitive values while preserving overall data pattern. Alternatively, various automated data filtering tools and scripts can be used to remove the proprietary and private data from the data elements.

In some embodiments, the data abstraction process further includes identifying and extracting one or more features from the data elements, such as session duration, data transfer rate, error rate, and time of day usage, etc., creating aggregated features over specific time periods (e.g., daily, weekly, monthly data usage), and generating features representing user behavior, such as frequency of data usage, average session length, etc. The extracted features can be used to perform segmentation/classification of the data elements based on predefined criteria such as usage patterns, geographical location, etc. Data segmentation based on features can further be used to classify the data elements and the data products. For example, a class identifier (ID) may be determined and assigned to the data product based on the extracted features, and the data product is identified as associated with a customer request, based at least in part on the class ID.

In some embodiments, the data abstraction process further includes analyzing the data elements and generate one or more reports of the analysis outcome that can be used for various purposes, including but not limited to performance monitoring, customer analysis, and regulatory compliance, etc.

At 806, the data products are provisioned to customers of the 5G network in response to customer request. In some embodiments, a request for service from a customer of the 5G network is received in a data management system included in the data abstraction layer. The request is analyzed to identify the data products related to the requested service. In some embodiments, the related network functions of the 5G network are identified, and one or more data products associated with the identified network functions are identified and determined to be related to the requested service. For example, the requested service is mapped to the relevant network functions within the 5G network, based on predefined associations between services and network functions. The specific data sources (e.g., user plane functions (UPFs), control plane functions (CPFs), management systems, etc.) that generate the data elements related to the requested service. In some embodiments, a catalog of available data products that have been predefined and categorized based on different use cases and services is accessed, and the relevant data products are identified.

In some embodiments, the customer request is analyzed to extract one or more features of the service, and the data product is identified based on a preestablished map specifying relationship between the class ID of the data product and the feature(s) of the service. The map may be a lookup table or database that links service features to corresponding data products.

In some embodiments, the class of the data product may indicate the network function(s) from which the data elements associated with the data product are generated from, and the data product may be identified based on the network function indicated by the class ID of the data elements. For example, each class ID in the preestablished map may indicate the specific network functions from which the data elements are generated. Based on the class ID of the data product identified, the network functions that generate the required data elements are determined.

In some embodiments, a stateless response is generated to provision the data products to the customer via one or more interface layers. The stateless response is treated as an independent transaction that is not reliant on previous customer requests. In other words, the data abstraction servers do not retain any session information or state information about the customer between different requests. Each customer request contains all the necessary information for the server to process it. The stateless response generated does not contain raw data of the data elements that was originally gathered from the infrastructure/physical infrastructure of the network. The stateless response only includes processed data products that have been abstracted, filtered, normalized, aggregated, and transformed. In some embodiments, the stateless response is also isolated from the physical infrastructure of the network and does not expose any underlying details or direct access to the raw data sources or the infrastructure itself. The stateless response is self-contained and contains all the information necessary for the customer to use the data products without needing additional context or reference to previous communications.

In some embodiments, the data products are converted into a required format as specified for the customer to use, packaged securely, and delivered to the customer via one or more interface layers.

The process steps performed in FIGS. 4, 6, and 8 may be performed by computer program(s), encoding instructions for the processor(s) to perform at least part of the process(es) described in FIGS. 4, 6, and 8, in accordance with embodiments of the present disclosure. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 710 of computing system 700 of FIG. 7) to implement all or part of the process steps described in FIGS. 4, 6, and 8, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present disclosure, as generally described and illustrated in the figures herein, may be arranged and designed in a wide variety of different configurations. Thus, the detailed description of the embodiments of the present disclosure, as represented in the attached figures, is not intended to limit the scope of the disclosure as claimed, but is merely representative of selected embodiments of the disclosure.

The features, structures, or characteristics of the disclosure described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present disclosure. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure can be practiced without one or more of the specific features or advantages of a particular embodiment. In other instances, additional features and advantages may be recognized in certain embodiments that may not be present in all embodiments of the disclosure.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the disclosure. In order to determine the metes and bounds of the disclosure, therefore, reference should be made to the appended claims.

What is claimed is:

1. A computer system comprising:
one or more processors; and
a computer-readable storage media storing computer-executable instructions, wherein, the instructions when executed by the one or more processors, cause the computer system to:
access data elements associated with a network function of a network;
perform abstraction on the data elements to generate one or more data products;
receive a customer request for a service on the network;
identify the data product related the service; and
provision the identified data product to the customer.

2. The computer system of claim 1, wherein the instructions when executed by the one or more processors, further cause the computer system to:
identify proprietary data and private data of the data elements based on a predefined policy; and
remove proprietary data and private data before performing abstraction.

3. The computer system of claim 1, wherein the instructions when executed by the one or more processors, further cause the computer system to:
determine that the service is associated with the network function.

4. The computer system of claim 1, wherein the instructions when executed by the one or more processors, further cause the computer system to:
extract one or more features from the data elements; and
determine a class of the data product based on the one or more features,
wherein the data product is identified as related to the service based at least in part on the class of the data product.

5. The computer system of claim 4, wherein the instructions when executed by the one or more processors, further cause the computer system to:
analyze the customer request to extract one or more features from the service,
wherein the data product is identified as related to the service, based on a preestablished map specifying a relationship between the class of the data product and the one or more features of the service.

6. The computer system of claim 1, wherein the instructions when executed by the one or more processors, further cause the computer system to:
generate a stateless response, the stateless response comprising the data product; and
transmit the stateless response to the customer.

7. The computer system of claim 6, wherein the stateless response does not expose raw data related to the data product and does not provide the customer with any access to the raw data.

8. The computer system of claim 1, wherein the instructions when executed by the one or more processors, further cause the computer system to:
analyze the data elements and generate a report,
wherein the report is included in the data product.

9. The computer system of claim 1, wherein the network function comprises at least one of Radio Unit (RU), Central Unit (CU), User Plane Function (UPF), Short Message Service Function (SMSF or SMF), Unified Data Repository (UDR), Network Exposure Function (NEF), Network Repository Function (NRF), Service Communication Proxy (SCP), Access and Mobility Management Function (AMF), Authentication Server Function (AUSF), Internet Protocol (IP) Multimedia Subsystem (IMS), Charging Function (CHF), and Unified Data Repository (UDR) function.

10. The computer system of claim 1, wherein the instructions when the service is selected from Application-to-Person (A2P) messaging service, location service, testing as a service, topology exploration service, data analytics services, and security service.

11. A method, performed by a data abstraction layer of a telecommunications system for a network, the method comprising:
accessing data elements associated with a network function of the network;
performing abstraction on the data elements to generate one or more data products;
receiving a customer request for a service on the network;
identifying the data product related the service; and
provisioning the identified data product to the customer.

12. The method of claim 11, further comprising:
identifying proprietary data and private data of the data elements based on a predefined policy; and
removing proprietary data and private data before performing abstraction.

13. The method of claim 11, further comprising:
determining that the service is associated with the network function.

14. The method of claim 11, further comprising:
extracting one or more features from the data elements; and
determining a class of the data product based on the one or more features,
wherein the data product is identified as related to the service based at least in part on the class of the data product.

15. The method of claim 14, further comprising:
analyzing the customer request to extract one or more features from the service,
wherein the data product is identified as related to the service, based on a preestablished map specifying a relationship between the class of the data product and the one or more features of the service.

16. The method of claim 11, further comprising:
generating a stateless response, the stateless response comprising the data product; and
transmitting the stateless response to the customer.

17. The method of claim 16, wherein the stateless response does not expose raw data related to the data product and does not provide the customer with any access to the raw data.

18. The method of claim 11, further comprising:
analyzing the data elements and generate a report,
wherein the report is included in the data product.

19. A telecommunications system for a network, the telecommunications system comprising:
an infrastructure layer comprising:
one or more infrastructure servers;
one or more network functions of the network executed on the one or more infrastructure servers; and
one or more data sources configured to store data elements generated by the one or more network functions;
a data abstraction layer comprising one or more data abstraction servers configured to:
access data elements associated with a network function of a network;
perform abstraction on the data elements to generate one or more data products;
receive a customer request for a service on the network;
identify the data product related the service; and
provision the identified data product to the customer.

20. The telecommunications system of claim 19, wherein the one or more data abstraction servers are further configured to:
identify proprietary data and private data of the data elements based on a predefined policy; and
remove proprietary data and private data before performing abstraction.
